(19) United States
(12) Patent Application Publication
(10) Pub. No.: US 2009/0051064 A1
(43) Pub. Date: Feb. 26, 2009

(54) Molding Machine Monitoring Apparatus, Method, and Program

(75) Inventor: Hidetoshi Tsukihara, Chiba (JP)

Correspondence Address: SQUIRE, SANDERS & DEMPSEY L.L.P., 8000 TOWERS CRESCENT DRIVE, 14TH FLOOR, VIENNA, VA, 22182-6212, US

(73) Assignee: Sumitomo Heavy Industries, Ltd.

(21) Appl. No.: 11/887,823

(22) PCT Filed: Apr. 11, 2006
(86) PCT No.: PCT/JP2006/307625

§ 371 Date: Oct. 4, 2007

(30) Foreign Application Priority Data
Apr. 11, 2005 (JP) 2005-113309

(51) Int. Cl. B29C 45/76

(52) U.S. Cl. 264/40.1; 425/169

(57) ABSTRACT

An object is to make it possible to calculate and set a threshold used for determining whether a molded product is good or defective, for each molding shot, to thereby enable an operator of a molding machine to easily set the threshold, and to determine whether a molded product is good or defective, while using a proper threshold, to thereby maintain a proper percent defective and enable accurate determination for molded products. To achieve the above object, there are provided a numerical value detection section which detects a numerical value representing a molding condition of a molding machine; a relation-deriving section which derives a relation between threshold and percent defective on the basis of the detected numerical value; a threshold-setting section which sets, in accordance with the derived relation, a threshold corresponding to a previously set target value of the percent defective; and a determination section which determines whether a molded product is good or defective through comparison between the detected numerical value and the set threshold.

### TECHNICAL FIELD

The present invention relates to a molding machine monitoring apparatus, method, and program.

### BACKGROUND ART

Conventionally, in a molding machine such as an injection molding machine, through advancement of a screw within a heating cylinder, heated and melted resin is injected under high pressure and charged into a cavity of a mold apparatus; and the resin within the cavity is cooled to set, thereby yielding a molded article. For such a molding machine, there has been proposed a method of monitoring a molding condition on the basis of change in a numerical value representing the molding condition, such as resin charging pressure or metering time (refer to, for example, Patent Document 1).

In the method of monitoring a molding condition on the basis of change in a numerical value representing the molding condition, a numerical range within which molded products are determined to be good is set on the basis of actual data of the numerical value representing the molding condition. When the detected numerical value falls within the numerical range, a molded product is determined to be good or non-defective. When the detected numerical value exceeds the upper limit value or the lower limit value, a molded product is determined to be defective. The molding condition is monitored in this manner.

Patent Document 1: Japanese Patent Application Laid-Open (kokai) No. H7-52207

### DISCLOSURE OF THE INVENTION

### Problems to be Solved by the Invention

However, in the conventional monitoring method, since the upper and lower limit values; i.e., thresholds set for determining whether a molded product is good or defective, are fixed, setting of the thresholds is difficult. Further, when the thresholds are not properly set, a percent defective—which is a probability at which a molded product is determined to be defective—becomes unreasonably high or unreasonably low. Moreover, in some cases, a numerical value representing a selected molding condition may change while molding is continued. In such a case, the percent defective changes, and erroneous determination occurs.

An object of the present invention is to solve the above-mentioned problems in the conventional technique and to provide a molding machine monitoring apparatus, method, and program which calculate and set a threshold used for determining whether a molded product is good or defective, for each molding shot, to thereby enable an operator of a molding machine to easily set the threshold, and which can determine whether a molded product is good or defective, while using a proper threshold, to thereby maintain a proper percent defective and enable accurate determination for molded products.

### Means for Solving the Problems

To achieve the above object, a molding machine monitoring apparatus of the present invention comprises a numerical value detection section which detects a numerical value representing a molding condition of a molding machine; a relation-deriving section which derives a relation between threshold and percent defective on the basis of the detected numerical value; a threshold-setting section which sets, in accordance with the derived relation, a threshold corresponding to a previously set target value of the percent defective; and a determination section which determines whether a molded product is good or defective through comparison between the detected numerical value and the set threshold.

In another molding machine monitoring apparatus of the present invention, the relation-deriving section derives the relation for each molding shot of the molding machine.

In still another molding machine monitoring apparatus of the present invention, the relation-deriving section derives the relation on the basis of the numerical value detected in each of a predetermined number of molding shots of the molding machine.

A molding machine monitoring method according to the present invention comprises the steps of deriving a relation between threshold and percent defective on the basis of a detected numerical value representing a molding condition of a molding machine; setting, in accordance with the derived relation, a threshold corresponding to a previously set target value of the percent defective; and determining whether a molded product is good or defective through comparison between the detected numerical value and the set threshold.

A molding machine monitoring program according to the present invention causes a computer for monitoring a molding machine to function as a numerical value detection section which detects a numerical value representing a molding condition of the molding machine; a relation-deriving section which derives a relation between threshold and percent defective on the basis of the detected numerical value; a threshold-setting section which sets, in accordance with the derived relation, a threshold corresponding to a previously set target value of the percent defective; and a determination section which determines whether a molded product is good or defective through comparison between the detected numerical value and the set threshold.

### EFFECT OF THE INVENTION

According to the present invention, the molding machine monitoring apparatus calculates and sets a threshold used for determining whether a molded product is good or defective, for each molding shot. Therefore, an operator of a molding machine can easily set the threshold, and determinations as to whether a molded product is good or defective can be performed through use of a proper threshold, whereby a proper percent defective can be attained, and determinations as to whether a molded product is good or defective can be performed accurately.

### BRIEF DESCRIPTION OF THE DRAWINGS

FIG. 1 is a schematic view of an injection molding machine according to an embodiment of the present invention.

FIG. 2 is a chart showing actual values of a numerical value representing a molding condition in the embodiment of the present invention.

FIG. 3 is a graph showing the relation between values of percent defective and threshold widths determined from actual values in the embodiment of the present invention.

FIG. 4 is a flowchart showing operation of a molding machine monitoring apparatus according to the embodiment of the present invention.

### DESCRIPTION OF REFERENCE NUMERALS

17: control section
18: management apparatus

### BEST MODE FOR CARRYING OUT THE INVENTION

An embodiment of the present invention will next be described with reference to the drawings. Although the present invention is applicable to various types of molding machines, for the sake of convenience, the embodiment will be described for the case where the present invention is applied to an injection molding machine.

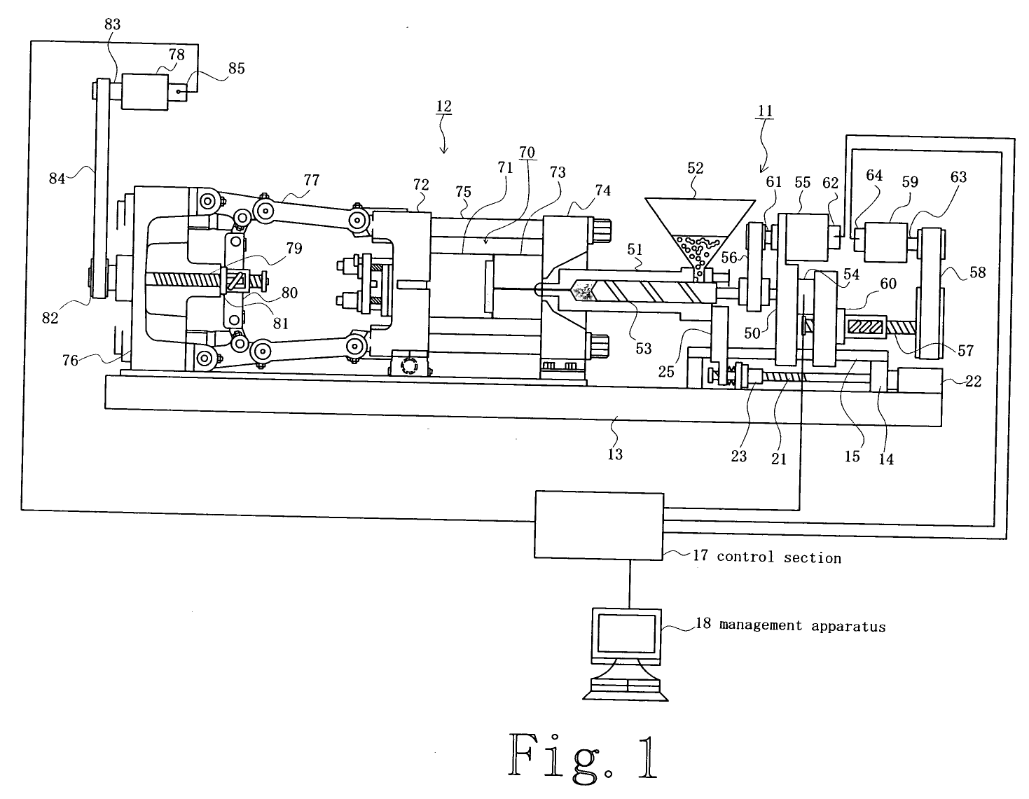

FIG. 1 is a schematic view of an injection molding machine according to the embodiment of the present invention.

In FIG. 1, reference numeral 11 denotes an injection apparatus; reference numeral 12 denotes a mold-clamping apparatus disposed in opposition to the injection apparatus 11; reference 13 denotes a molding machine frame supporting the injection apparatus 11 and the mold-clamping apparatus 12; reference numeral 14 denotes an injection apparatus frame supported by the molding machine frame 13 and supporting the injection apparatus 11; reference number 15 denotes a guide disposed along the longitudinal direction of the injection apparatus frame 14; and reference numeral 70 denotes a mold apparatus composed of a stationary mold 73 and a movable mold 71. Notably, a cavity is formed in the mold apparatus 70.

A ball screw shaft 21 is rotatably supported by the injection apparatus frame 14, and one end of the ball screw shaft 21 is connected to a motor 22. The ball screw shaft 21 is in screw-engagement with a ball screw nut 23, which is connected to the injection apparatus 11 via a bracket 25. Therefore, when the motor 22 is driven in a regular direction or a reverse direction, rotational motion of the motor 22 is converted to linear motion by means of a combination of the ball screw shaft 21 and the ball screw nut 23; i.e., a ball screw transmission apparatus, and the linear motion is transmitted to the bracket 25. Thus, the bracket 25 is moved along the guide 15, whereby the injection apparatus 11 is advanced and retreated.

A heating cylinder 51 is fixed to the bracket 25 to extend frontward (leftward in FIG. 1), and an injection nozzle is disposed at the front end (left end in FIG. 1) of the heating cylinder 51. A hopper 52 is disposed on the heating cylinder 51, and a screw 53 is disposed within the heating cylinder 51 such that the screw can rotate and can advance and retreat (can move in a left-right direction in FIG. 1). The rear end (right end in FIG. 1) of the screw 53 is supported by a support member 50.

A screw rotation motor 55 is attached to the support member 50. Rotation generated upon drive of the screw rotation motor 55 is transmitted to the screw 53 via a timing belt 56. A first pulse encoder 62 is attached to the screw rotation motor 55 so as to detect rotation of a rotary shaft 61 of the screw rotation motor 55. Notably, a load cell 54 is attached to the support member 50 so as to detect pressure received by the screw 53.

Further, a ball screw shaft 57 is rotatably supported on the injection apparatus frame 14 in parallel to the screw 53, and is connected to an injection motor 59 via a timing belt 58. The front end of the ball screw shaft 57 is in screw-engagement with a ball screw nut 60 fixed to the support member 50. Therefore, when the injection motor 59 is driven, rotational motion of the injection motor 59 is converted to linear motion by means of a combination of the ball screw shaft 57 and the ball screw nut 60; i.e., a ball screw transmission apparatus, and the linear motion is transmitted to the support member 50. Further, a second pulse encoder 64 is attached to the injection motor 59 so as to detect rotation of a rotary shaft 63 of the injection motor 59.

Next, general operation of the injection apparatus 11 having the above-described configuration will be described.

First, in a metering step, the screw rotation motor 55 is driven so as to rotate the screw 53 via the timing belt 56 to thereby retreat (move rightward in FIG. 1) the screw 53 to a predetermined position. At this time, resin supplied from the hopper 52 is heated and melted within the heating cylinder 51, and the molten resin is accumulated forward of the screw 53 as the screw 53 retreats.

Next, in an injection step, the injection nozzle of the heating cylinder 51 is pressed against the stationary mold 73, and the injection motor 59 is driven so as to rotate the ball screw 57 via the timing belt 58. At this time, as the ball screw shaft 57 rotates, the support member 50 is moved so as to advance (move leftward in FIG. 1) the screw 53. Therefore, the resin accumulated forward of the screw 53 is injected from the injection nozzle, and is charged into a cavity formed between the stationary mold 73 and the movable mold 71, via a resin passage formed in the stationary mold 73.

Next, the aforementioned mold-clamping apparatus 12 will be described.

The mold-clamping apparatus 12 includes a stationary platen 74; a toggle support 76; tie bars 75 extending between the stationary platen 74 and the toggle support 76; a movable platen 72, which is disposed in opposition to the stationary platen 74 in a manner capable of advancing and retreating along the tie bars 75; and a toggle mechanism disposed between the movable platen 72 and the toggle support 76. The stationary mold 73 and the movable mold 71 are attached to the stationary platen 74 and the movable platen 72, respectively, in such a manner that the stationary mold 73 and the movable mold 71 face each other.

The toggle mechanism is configured such that when a cross head 80 is advanced and retreated between the toggle support 76 and the movable platen 72 by means of a mold-clamping motor 78, the movable platen 72 is advanced and retreated along the tie bars 75 so as to bring the movable mold 71 into contact with the stationary mold 73 and separate the movable mold 71 from the stationary mold 73, to thereby perform mold closing, mold clamping, and mold opening.

For such operation, the toggle mechanism includes first toggle levers pivotably supported by the crosshead 80; second toggle levers pivotably supported by the toggle support 76; and toggle arms 77 pivotably supported by the movable platen 72. The first toggle levers and the second toggle levers are linked together, and the second toggle levers and the toggle arms 77 are linked together.

Further, a ball screw shaft 79 is rotatably supported by the toggle support 76, and is in screw-engagement with a ball screw nut 81 fixed to the crosshead 80. In order to rotate the ball screw shaft 79, a pulley 82 is attached to an end portion of the ball screw shaft 79 opposite the ball screw nut 81, and the pulley 82 is rotated by the mold-clamping motor 78 via a timing belt 84. Further, a third pulse encoder 85 is attached to the mold-clamping motor 78 so as to detect rotation of a rotary shaft 83 of the mold-clamping motor 78.

Therefore, when the mold-clamping motor 78 is driven, rotational motion of the mold-clamping motor 78 is transmitted to the ball screw shaft 79 via the timing belt 84, and is converted to linear motion by means of a combination of the ball screw shaft 79 and the ball screw nut 81; i.e., a ball screw transmission apparatus, and the linear motion is transmitted to the cross head 80, whereby the crosshead 80 is advanced and retreated. When the cross head 80 is advanced (moved rightward in FIG. 1), the toggle mechanism expands so that the movable platen 72 is advanced so as to perform mold closing and mold clamping. When the cross head 80 is retreated (moved leftward in FIG. 1), the toggle mechanism contracts so that the movable platen 72 is retreated so as to perform mold opening.

Further, an ejector apparatus is disposed on the rear side of the movable platen 72 and includes an unillustrated ejector pin which extends through the movable mold 71 such that its front end (right end in FIG. 1) faces the cavity; an unillustrated ejector rod disposed rearward (leftward in FIG. 1) of the ejector pin; a ball screw shaft disposed rearward of the ejector rod and rotated by an unillustrated servomotor; and a ball screw nut in screw engagement with the ball screw shaft.

Therefore, when the servomotor is driven, rotational motion of the servomotor is converted to linear motion by means of a combination of the ball screw shaft and the ball screw nut; i.e., a ball screw transmission apparatus, and the linear motion is transmitted to the ejector rod, whereby the ejector rod and the ejector pin are advanced and retreated.

Notably, the injection molding machine includes a control section 17 for controlling operations of the mold-clamping motor 78, the screw rotation motor 55, and the injection motor 59. The control section 17 is a computer which includes computation means (e.g., a CPU, an MPU, etc.), storage means (e.g., a magnetic disc, a semiconductor memory, etc.), an input/output interface, etc. The control section 17 controls not only operations of the mold-clamping motor 78, the screw rotation motor 55, and the injection motor 59, but also the entire operation of the injection molding machine. Further, the control section 17 receives output signals from the load cell 54, the first pulse encoder 62, the second pulse encoder 64, the third pulse encoder 85, etc., and detects not only the pressure received by the screw 53 and the rotations of the rotary shaft 61 of the screw rotation motor 55, the rotary shaft 63 of the injection motor 59, and the rotary shaft 83 of the mold-clamping motor 78, but also various numerical values representing molding conditions in the injection molding machine.

A management apparatus 18 is connected to the control section 17. The management apparatus 18 is a computer which includes computation means (e.g., a CPU, an MPU, etc.); storage means (e.g., a magnetic disc, a semiconductor memory, etc.); an input/output interface; an input section including a keyboard, a joystick, a touch panel, etc.; a display section including a CRT, a liquid crystal display, an LED (Light Emitting Diode) display, or the like; etc. For example, the management apparatus 18 may be a personal computer, a server, a workstation, or the like; however, the management apparatus 18 may be any apparatus.

In the present embodiment, the control section 17 and the management apparatus 18 function as a molding machine monitoring apparatus for monitoring the injection molding machine. In this case, from the viewpoint of functions, the control section 17 and the management apparatus 18, functioning as a molding machine monitoring apparatus, have a numerical value detection section which detects a numerical value representing a molding condition of the injection molding machine; a relation-deriving section which derives a relation between threshold and percent defective on the basis of the numerical value detected by the numerical value detection section; a threshold-setting section which sets, in accordance with the relation derived by the relation-deriving section, a threshold corresponding to a previously set target value of the percent defective; and a determination section which determines whether a molded product is good or defective through comparison between the detected numerical value and the set threshold.

The management apparatus 18 monitors the molding condition of the injection molding machine on the basis of change in the numerical value representing the molding condition. When the detected numerical value is within a threshold width, serving as the set threshold, a molded product is determined to be good. When the detected numerical value is not within the threshold width; i.e., the detected numerical value exceeds the threshold, a molded product is determined to be defective.

When the management apparatus 18 determines that a molded product is defective, the molded product is desirably transferred, by means of an unillustrated mold product removal apparatus or the like, to a location different from a location to which molded products having being determined to be good are transferred. Further, through operation of the input section, an operator sets the threshold for determining whether a molded product is good or defective. The management apparatus 18 calculates and sets the threshold for each molding shot, and determines whether a molded product is good or defective, on the basis of the set threshold.

Next, operation of the molding machine monitoring apparatus having the above-described configuration will be described.

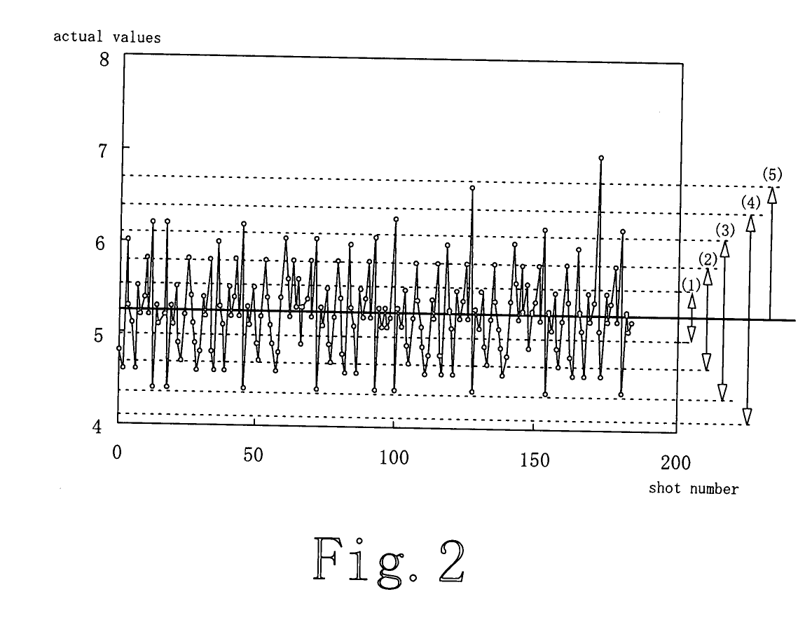

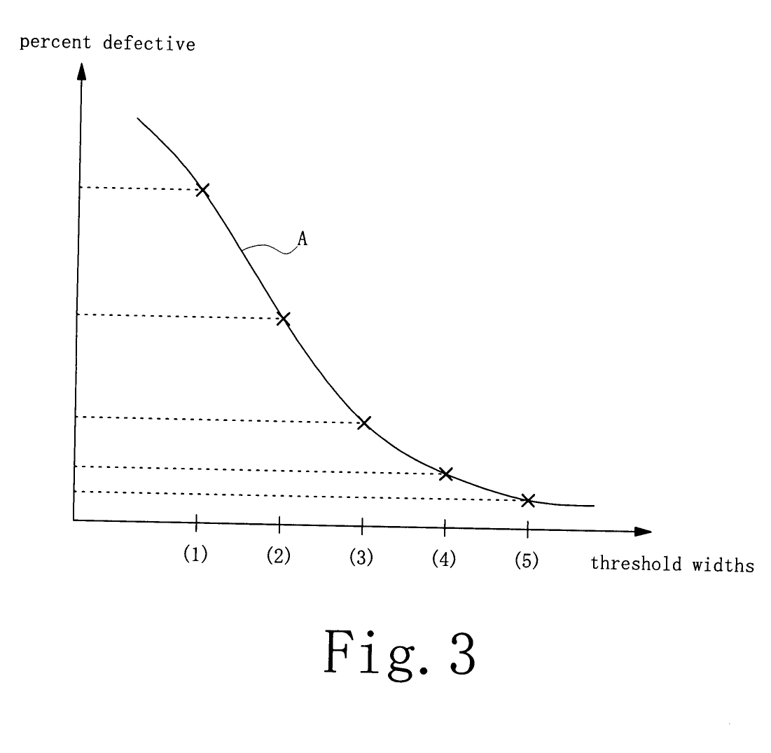

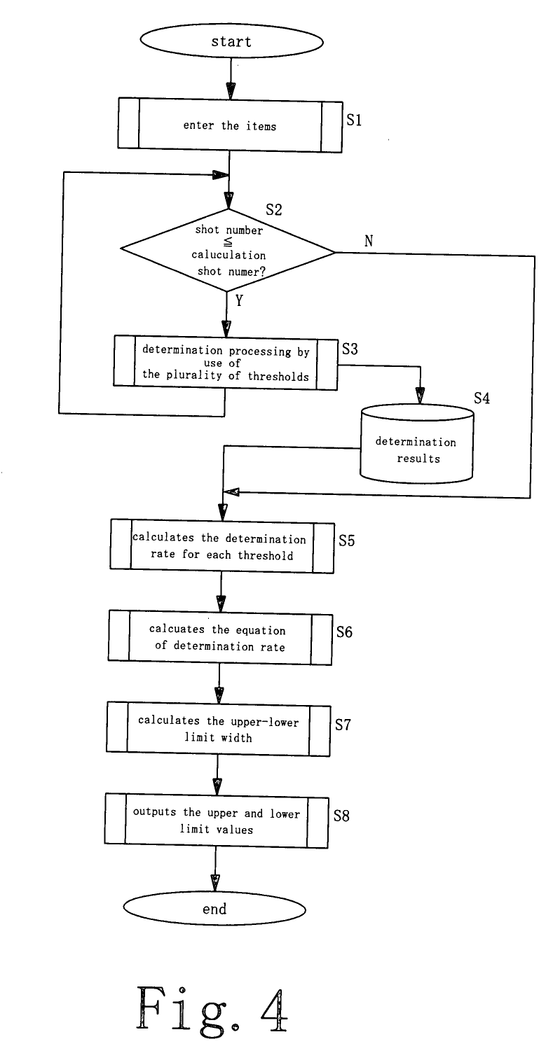

FIG. 2 is a chart showing actual values of a numerical value representing a molding condition in the embodiment of the present invention. FIG. 3 is a graph showing the relation between values of percent defective and threshold widths determined from actual values in the embodiment of the present invention. FIG. 4 is a flowchart showing operation of the molding machine monitoring apparatus according to the embodiment of the present invention. Notably, in FIG. 2, the vertical axis represents actual value, and the horizontal axis represents shot number; and, in FIG. 3, the vertical axis represents percent defective, and the horizontal axis represents threshold width.

First, an operator enters various items through operation of the input section of the management apparatus 18. In this case, the entered items include calculation shot number, center value, threshold width, target determination rate, etc. Here, the term “calculation shot number” refers to the number of molding shots, after completion of which the management apparatus 18 starts calculation of the threshold. The calculation shot number is 100, for example; however, the calculation number may be set arbitrarily.

The terms “center value” refers to the center value of the numerical value representing the molding condition of the injection molding machine, and may be the arithmetic average, median, or the like of the numerical value. Notably, the numerical value representing the molding condition may be the peak charge pressure of resin, resin metering time, pressure-holding completion position, minimum cushion position, or the like; however, any types of numerical values may be used. Of these numerical values, one or a plurality of types of numerical values may be used as the numerical value representing the molding condition. Alternatively, multivariate analysis may be performed by use of the Maharanobis distance, based on a large number of types of numerical values. Here, there will be described a case where a dimensionless number obtained by performing multivariate analysis on the basis of eight types of numerical values is used as the numerical value representing the molding condition.

Moreover, the term “threshold width” refers to the width of a numerical range from a lower limit value to an upper limit value, which values are set such that the center value is centrally located therebetween and which serve as the threshold of the numerical value. When the detected numerical value is within the threshold width; i.e., between the lower limit value and the upper limit value, a molded product is determined to be good. When the detected numerical value is not within the threshold width; i.e., the detected numerical value exceeds the lower limit value or the upper limit value, a molded product is determined to be defective. The term “target determination rate” refers to a target value of percent defective—which is a probability at which a molded product is determined to be defective. The target determination rate is 2%, for example; however, the target determination rate may be set arbitrarily.

When molding by the injection molding machine is started after completion of input of the various items, the management apparatus 18 determines whether or not the shot number (i.e., the number of molding shots performed by the injection molding machine) is equal to or less than the calculation shot number. When the shot number is equal to or less than the calculation shot number, the management apparatus 18 performs determination processing while using a plurality of thresholds, and determines whether or not a molded product is good. That is, the management apparatus 18 performs the determination on the basis of a plurality of previously set threshold widths in such a manner as to determine that a molded product is good when the detected value is within a threshold width and that a molded product is defective when the detected value is not within the threshold width. Notably, as shown in FIG. 2, the plurality of threshold widths include five threshold widths (1) to (5) set around the center value. In this case, the threshold width (1) is the narrowest; the threshold width increases as the numerical value in parentheses increases; and the threshold width (5) is the widest. Notably, in FIG. 2, because of limited space, only the upper half of the threshold width (5) is shown, and the lower half thereof is omitted.

FIG. 2 shows actual values of the numerical value representing the molding condition in the embodiment of the present invention. It can be understood from FIG. 2 that the numerical value representing the molding condition changes for every molding shot. The smaller the numerical value in parentheses; i.e., the narrower the threshold width, the greater the number of cases in which the numerical value representing the molding condition is not within the threshold width; i.e., the greater the number of cases in which a molded product is determined defective. Meanwhile, the larger the numerical value in parentheses; i.e., the wider the threshold width, the smaller the number of cases in which the numerical value representing the molding condition is not within the threshold width; i.e., the smaller the number of cases in which a molded product is determined defective. The management apparatus 18 stores the determination results in the storage means, and again determines whether or not the shot number is equal to or less than the calculation shot number. Notably, the determination results are stored while being related to the threshold widths.

Next, the management apparatus 18 calculates the determination rate for each threshold. That is, the management apparatus 18 calculates a percent defective corresponding to each threshold width, on the basis of determination results stored in the storage means. Notably, when the shot number is determined not to be equal to or less than the calculation shot number; i.e., when the number of molding shots exceeds the calculation shot number entered by the operator, the management apparatus 18 calculates the determination rate for each threshold, without performing the determination processing by use of the plurality of thresholds.

Subsequently, the management apparatus 18 calculates an equation of determination rate on the basis of the determination rate for each threshold. That is, the management apparatus 18 derives the relation between threshold and percent defective by calculating an equation showing a curve A as shown in FIG. 3. The curve A represents the relation between the five set threshold widths (1) to (5) and percent defectives corresponding to the threshold widths (1) to (5); i.e., the relation between threshold and percent defective. The curve A shows that the narrower the threshold width, the higher the percent defective, and the wider the threshold width, the lower the percent defective.

Subsequently, the management apparatus 18 sets thresholds corresponding to a previously set target value of percent defective, in accordance with the derived relation between threshold and percent defective; that is, the management apparatus 18 calculates a width between upper and lower limits (hereinafter referred to as an “upper-lower limit width”). Specifically, from the curve A shown in FIG. 3, the management apparatus 18 calculates an upper-lower limit width, which serves as a threshold width with which the target determination rate entered by the operator can be obtained. For example, when the target value of percent defective (i.e., the target determination rate) is 2%, the management apparatus 18 calculates, as the upper-lower limit width, the value of threshold width indicated by the point on the curve A corresponding to the defective of 2%. Thus, the upper and lower limit values, between which the set center value is centrally located, can be calculated. The management apparatus 18 then outputs the upper and lower limit values, and ends the processing.

With this processing, the upper and lower limit values, which serve as the threshold for determining whether a molded product is good or defective, can be obtained for each molding shot. The management apparatus 18 compares the detected numerical value representing the molding condition with the set threshold to thereby determine whether a molded product is good or defective. When the detected numerical value representing the molding condition is between the upper and lower limit values, the management apparatus 18 determines that a molded product is good. When the detected numerical value exceeds the upper limit value or the lower limit value, the management apparatus 18 determines that the molded product is defective. By virtue of the above-described processing, even when the numerical value representing the molding condition changes while molding is continued, the percent defective does not change, and erroneous determination can be prevented. Therefore, the percent defective—which is a probability at which a molded product is determined to be defective—coincides with the entered target value, and becomes a proper value.

Further, determination as to whether a molded product is good or defective can be performed by use of upper and lower limit values determined through a predetermined number of latest molding shots (e.g., 100 shots). Moreover, the upper and lower limit values may be output by performing the above-described processing for a predetermined number of shots after the injection molding machine starts molding; for example, 100 shots after the injection molding machine resumes operation after having stopped due to an error, or 100 shots after the injection molding machine resumes operation after replacement of the mold apparatus.

Next, the flowchart will be described.

Step S1: the operator enters the various items through operation of the management apparatus 18.
Step S2: the management apparatus 18 determines whether or not the shot number is equal to or less than the calculation shot number. When the shot number is equal to or less than the calculation shot number, the management apparatus 18 proceeds to Step S3. When the shot number is greater than the calculation shot number, the management apparatus 18 proceeds to Step S5.
Step S3: the management apparatus 18 performs the determination processing by use of the plurality of thresholds.
Step S4: the management apparatus 18 stores the determination results in the storage means.
Step S5: the management apparatus 18 calculates the determination rate for each threshold.
Step S6: the management apparatus 18 calculates the equation of determination rate.
Step S7: the management apparatus 18 calculates the upper-lower limit width.
Step S8: the management apparatus 18 outputs the upper and lower limit values, and ends the processing.

As described above, in the present embodiment, the numerical value representing the molding condition of the injection molding machine is detected; the relation between threshold and percent defective is derived on the basis of the detected numerical value; a threshold corresponding to a desired percent defective is set in accordance with the derived relation; and determination as to whether a molded product is good or defective is performed by use of the set threshold. Therefore, the threshold width, which serves as the threshold used for determining whether a molded product is good or defective, can be calculated and set for each molding shot. Therefore, even when the numerical value representing the molding condition changes while molding is continued, the percent defective does not change, and erroneous determination can be prevented.

Further, the operator of the injection molding machine can readily set the threshold used for determining whether a molded product is good or defective, by merely inputting the calculation shot number, center value, threshold width, target determination rate, etc.

Moreover, since the determination as to whether a molded product is good or defective can be performed by making use of a proper threshold value, the percent defective—which is a probability at which a molded product is determined to be defective—can be maintained at a proper value. That is, when the percent defective of molded products determined on the basis of the detected numerical value increases, the threshold width is set to become wider; and when the percent defective of molded products determined on the basis of the detected numerical value decreases, the threshold width is set to become narrower. Therefore, the target determination rate (target percent defective) can be maintained. Therefore, determination of molded products can be performed accurately, without lowering the productivity of the injection molding machine.

The present invention is not limited to the above-described embodiments. Numerous modifications and variations of the present invention are possible in light of the spirit of the present invention, and they are not excluded from the scope of the present invention.

### INDUSTRIAL APPLICABILITY

The present invention can be applied to a molding machine monitoring apparatus, method, and program.

1. A molding machine monitoring apparatus characterized by comprising:
a numerical value detection section which detects a numerical value representing a molding condition of a molding machine;
a relation-deriving section which derives a relation between threshold and percent defective on the basis of the detected numerical value;
a threshold-setting section which sets, in accordance with the derived relation, a threshold corresponding to a previously set target value of the percent defective; and
a determination section which determines whether a molded product is good or defective through comparison between the detected numerical value and the set threshold.

2. A molding machine monitoring apparatus according to claim 1, wherein the relation-deriving section derives the relation for each molding shot of the molding machine.

3. A molding machine monitoring apparatus according to claim 1, wherein the relation-deriving section derives the relation on the basis of the numerical value detected in each of a predetermined number of molding shots of the molding machine.

4. A molding machine monitoring method characterized by comprising the steps of:
deriving a relation between threshold and percent defective on the basis of a detected numerical value representing a molding condition of a molding machine;
setting, in accordance with the derived relation, a threshold corresponding to a previously set target value of the percent defective; and
determining whether a molded product is good or defective through comparison between the detected numerical value and the set threshold.

5. A molding machine monitoring program characterized in that the program causes
a computer that monitors a molding machine to function as:
a numerical value detection section which detects a numerical value representing a molding condition of the molding machine;
a relation-deriving section which derives a relation between threshold and percent defective on the basis of the detected numerical value;
a threshold-setting section which sets, in accordance with the derived relation, a threshold corresponding to a previously set target value of the percent defective; and
a determination section which determines whether a molded product is good or defective through comparison between the detected numerical value and the set threshold.
